(19) United States
(12) Patent Application Publication
(10) Pub. No.: US 2021/0176397 A1
(43) Pub. Date: Jun. 10, 2021

(54) SHARED IMAGE SENSOR FOR MULTIPLE OPTICAL PATHS

(71) Applicant: QUALCOMM Incorporated, San Diego, CA (US)

(72) Inventors: Erik MÜLLER, Munchen (DE); Florian LOCHNER, Munchen (DE)

(21) Appl. No.: 16/705,095

(22) Filed: Dec. 5, 2019

(51) Int. Cl. H04N 5/232; G03B 17/17

(52) U.S. Cl. CPC H04N 5/23245; H04N 5/23296; G03B 17/17

(57) ABSTRACT

Aspects of the present disclosure relate to a shared image sensor. An example device includes a first lens configured to direct light along a first path in the device, a second lens configured to direct light along a second path in the device, an image sensor configured to receive light from a third path in the device, and an optical element configured to direct the light from the first path to the third path during a first mode. The image sensor is configured to receive the light from the first path during the first mode, and the image sensor is configured to receive the light from the second path during a second mode.

### TECHNICAL FIELD

This disclosure relates generally to image capture systems and devices, including a shared image sensor for multiple optical paths of a device.

### BACKGROUND

Many devices may include multiple cameras. For example, a smartphone may include a plurality of cameras rear facing cameras and one or more front facing cameras. Each camera includes an image sensor and associated components for capturing an image. For example, if a device includes two or more cameras, the device includes two or more image sensors and associated components.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to a shared image sensor. An example device includes a first lens configured to direct light along a first path in the device, a second lens configured to direct light along a second path in the device, an image sensor configured to receive light from a third path in the device, and an optical element configured to direct the light from the first path to the third path during a first mode. The image sensor is configured to receive the light from the first path during the first mode, and the image sensor is configured to receive the light from the second path during a second mode.

In another example, a method is disclosed. The example method includes directing, by a first lens, light along a first path in a device when the device is in a first mode. The method also includes directing, by a second lens, light along a second path in the device when the device is in a second mode. The method further includes receiving, by an image sensor, light from a third path in the device. The method also includes directing, by an optical element, light from the first path to the third path during the first mode. The image sensor is configured to receive the light from the first path during the first mode, and the image sensor is configured to receive the light from the second path during the second mode.

In a further example, a non-transitory computer-readable medium is disclosed. The non-transitory computer-readable medium may store instructions that, when executed by a processor, cause a device to direct, by a first lens, light along a first path in a device when the device is in a first mode. Execution of the instructions also causes the device to direct, by a second lens, light along a second path in the device when the device is in a second mode. Execution of the instructions further causes the device to receive, by an image sensor, light from a third path in the device. Execution of the instructions also causes the device to direct, by an optical element, light from the first path to the third path during the first mode. The image sensor is configured to receive the light from the first path during the first mode, and the image sensor is configured to receive the light from the second path during the second mode.

In another example, a device is disclosed. The device includes means for directing light along a first path in the device when the device is in a first mode, means for directing light along a second path in the device when the device is in a second mode, means for receiving at an image sensor light from a third path in the device, and means for directing light from the first path to the third path during the first mode. The image sensor is configured to receive the light from the first path during the first mode, and the image sensor is configured to receive the light from the second path during the second mode.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a block diagram of an example device including a shared image sensor for multiple optical paths.

FIG. 2A is a depiction of a device in a first mode configured to direct light from a first optical path to an image sensor.

FIG. 2B is a depiction of the device in FIG. 2A in a second mode configured to direct light from a second optical path to the image sensor.

FIG. 2C is a depiction of a device in a first mode configured to direct light from a first optical path to an image sensor.

FIG. 2D is a depiction of the device in FIG. 2C in a second mode configured to direct light from a second optical path to the image sensor.

FIG. 3 is a depiction of an example device including two lenses on the rear of the device.

FIG. 4A is a depiction of a device in a first mode configured to direct light from a first optical path to an image sensor.

FIG. 4B is a depiction of the device in FIG. 4A in a second mode configured to direct light from a second optical path to the image sensor.

FIG. 5A is a depiction of an example device including a lens on the rear of the device.

FIG. 5B is a depiction of the example device in FIG. 5A including a lens on the front of the device.

FIG. 6A is a depiction of an example device in a first mode exposing a first lens for directing light to a first optical path, which is directed to the image sensor.

FIG. 6B is a depiction of the example device in FIG. 6A in a second mode hiding the first lens and configured to direct light from a second optical path to the image sensor.

FIG. 7A is a depiction of an example device with a first lens hidden behind a display.

FIG. 7B is a depiction of the example device in FIG. 7B with the first lens positioned outside of the display.

FIG. 8A is a depiction of a device in a first mode configured to direct light from a first optical path to an image sensor.

FIG. 8B is a depiction of the device in FIG. 8A in a second mode configured to direct light from a second optical path to the image sensor.

FIG. 8C is a depiction of a device in a first mode configured to direct light from a first optical path to an image sensor.

FIG. 8D is a depiction of the device in FIG. 8C in a second mode configured to direct light from a second optical path to the image sensor.

FIG. 9A is a depiction of a device in a first mode configured to direct light from a first optical path to an image sensor.

FIG. 9B is a depiction of the device in FIG. 9A in a second mode configured to direct light from a second optical path to the image sensor.

FIG. 10 is an illustrative flow chart depicting an example operation for sharing an image sensor between multiple optical paths.

FIG. 11 is an illustrative flow chart depicting another example operation for sharing an image sensor between multiple optical paths.

### DETAILED DESCRIPTION

Aspects of the present disclosure may be used for image capture systems and devices. Some aspects may include a device having a shared image sensor for multiple optical paths of the device.

For a device having multiple cameras, each camera includes an image sensor, a lens, and other camera components (such as a shutter, front end, color filter, and so on). For example, a device (such as a smartphone, tablet, digital camera, or other suitable imaging device) may include a rear facing dual camera module and a front facing camera. As a result, the device includes at least three image sensor and corresponding camera components. Multiple image sensors may be used to capture images, for example, from different perspectives, using different fields of view, or using different optical zooms. While increasing the number of image sensor may increase the camera functionality of a device, including additional image sensors increases the cost of the device. Additionally, multiple image sensors occupy space in a device that may have been used for other purposes, such as accommodating a larger capacity battery or other device components. Device manufacturers may use lower resolution or less capable image sensors for at least some of the cameras (such as for an auxiliary camera or front facing camera) to reduce cost. However, the image sensor may be associated with a low quality image, and the less capable image sensors still occupy device space that may be used for other components.

In some implementations, a device may include an image sensor that is shared between two or more optical paths in the device. For example, two or more lenses on the device may direct light along its associated optical path, and the device may be configured to switch between optical paths to be coupled to a shared image sensor. In this manner, one high resolution, highly capable image sensor may be used for image capture, for example, from different perspectives, for different fields of view, or at different optical zoom levels.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device including an image sensor configured to capture images or video (such as security systems, smartphones, tablets, laptop computers, digital video and/or still cameras, web cameras, and so on with an image sensor). While described below with respect to a device including one image sensor shared by two optical paths, aspects of the present disclosure are applicable to devices having any number of image sensors and any number of optical paths sharing an image sensor. For example, a device may include three or more optical paths sharing an image sensor. Therefore, the present disclosure is not limited to devices having one image sensor shared by two optical paths.

The term “device” is not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects.

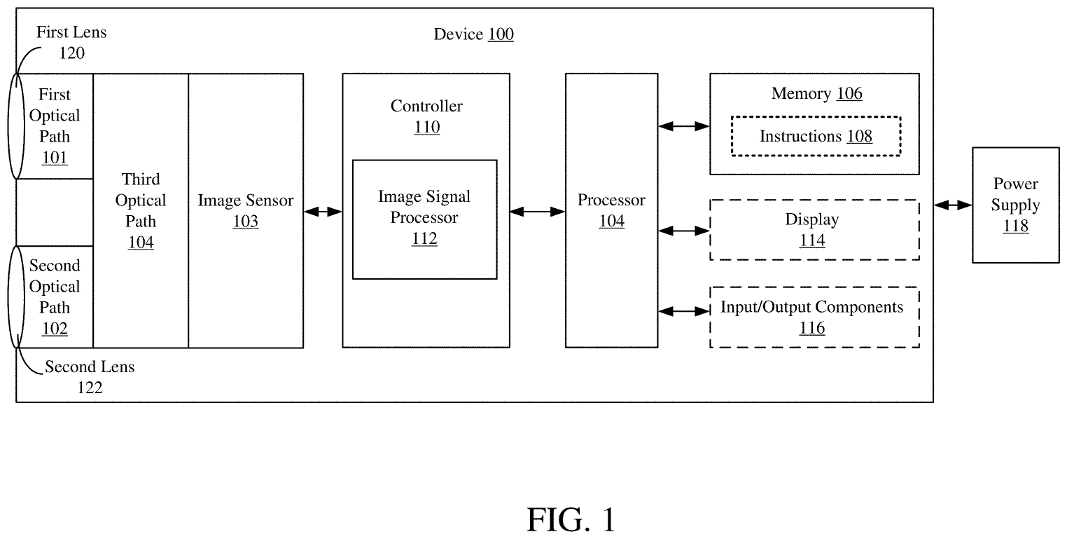

FIG. 1 is a block diagram of an example device 100. The example device 100 may include a first lens 120 to direct light to a first optical path 101, a second lens 122 to direct light to a second optical path 102, and an image sensor 103 coupled to a third optical path 104. The device 100 may be configured to couple the first optical path 101 to the third optical path 104 (and therefore the image sensor 103) during a first mode and to couple the second optical path 102 to the third optical path 104 (and therefore the image sensor 103) during a second mode. The example device 100 also may include a processor 104, a memory 106 storing instructions 108, and a camera controller 110. The device 100 optionally may include (or be coupled to) a display 114 and a number of input/output (I/O) components 116. The device 100 may include additional features or components not shown. In one example, a wireless interface, which may include a number of transceivers and a baseband processor, may be included for a wireless communication device. In another example, one or more motion sensors (such as a gyroscope) may be included in a device. The device 100 may include or be coupled to additional image sensors other than the image sensor 103 and may include or be coupled to additional lenses other than the first lens 120 and the second lens 122.

The first lens 120 and the second lens 122 may be capable of receiving light from any perspective of the device 100. For example, if the device 100 is a smartphone, the first lens 120 and the second lens 122 may be positioned on any side of the smartphone, and the lenses 120 and 122 may be positioned on the same side (such as both rear facing) or on different sides (such as one rear facing and one forward facing). If the lenses 120 and 122 are positioned on the same side of the device 100, the fields of view may be overlapping or exclusive of each other (such as if the lenses are parallel, toed-in, or toed-out).

The first lens 120 may be configured to provide a first field of view, a first perspective, or a first optical zoom for images to be captured by the image sensor from the first optical path. For example, a curvature of the first lens 120 may cause a desired optical zoom. In another example, the first lens 120 may be a flat, transparent cover to protect the device from receiving dust and other materials in the first optical path. In this manner, the first lens 120 may or may not refract light to cause an optical effect such as a zoom or change in field of view. The lens 120 may include any material and any properties for directing light to the first optical path. For example, the lens may be glass and plastic.

The second lens 122 may be similar or different than the first lens 120. For example, the curvature of the second lens 122 may differ from the curvature of the first lens 120 to cause a different optical zoom or different field of view, one lens may include a mask to restrict the field of the scene from which light may be received (such as to adjust the field of view), or the lenses 120 and 122 may be of different materials. Alternatively, the first lens 120 and the second lens 122 may be similar. In some implementations, the first lens 120 may be fixed in position with reference to the second lens 122. In some other implementations, the position of the first lens 120 may move with reference to the position of the second lens 122. For example, the first lens may be positioned outside of a display of a smartphone (and the second lens may be fixed to the rear of the smartphone) during a first mode, and the first lens may be positioned behind the display during a second mode.

The image sensor 103 may be configured to capture images of a scene based on the light received at the first lens 120 or the light received at the second lens 122. In some implementations, when the device 100 is in a first mode, the image sensor 103 is configured to receive light from the first optical path 101 coupled to the third optical path 104. When the device 100 is in a second mode, the image sensor 103 is configured to receive light from the second optical path 102 coupled to the third optical path 104. In some example implementations, the device 100 may include an optical element (not shown) to cause the device 100 to switch between the first mode and the second mode. For example, the device 100 (such as using the optical element) may switch between coupling the first optical path 101 to the third optical path 104 during the first mode and coupling the second optical path 102 to the third optical path 104 during the second mode. In some implementations, the optical element may include a reflective surface and be moveable between a first position for a first mode and a second position for a second mode. If the image sensor 103 is shared by additional optical paths, the optical element may be configured to be moved to more than two positions (such as a third position to couple an additional optical path to the third optical path 104 preceding the image sensor 103).

The memory 106 may be a non-transient or non-transitory computer readable medium storing computer-executable instructions 108 to perform all or a portion of one or more operations described in this disclosure (such as for adjusting a position of an optical element). The device 100 also may include a power supply 118, which may be coupled to or integrated into the device 100. The processor 104 may be one or more suitable processors capable of executing scripts or instructions of one or more software programs (such as instructions 108) stored within the memory 106. For example, the processor 104 may be an applications processor and execute an imaging application. In another example, the processor 104 may execute instructions to cause the device to adjust a position of an optical element (such as control an actuator to adjust the position of the optical element). In some aspects, the processor 104 may be one or more general purpose processors that execute instructions 108 to cause the device 100 to perform any number of functions or operations. In additional or alternative aspects, the processor 104 may include integrated circuits or other hardware to perform functions or operations without the use of software.

While shown to be coupled to each other via the processor 104 in the example of FIG. 1, the processor 104, the memory 106, the camera controller 110, the optional display 114, and the optional I/O components 116 may be coupled to one another in various arrangements. For example, the processor 104, the memory 106, the camera controller 110, the optional display 114, and/or the optional I/O components 116 may be coupled to each other via one or more local buses (not shown for simplicity).

The display 114 may be any suitable display or screen allowing for user interaction and/or to present items (such as captured images, video, or preview images from the image sensor 103). In some aspects, the display 114 may be a touch-sensitive display. The I/O components 116 may be or include any suitable mechanism, interface, or device to receive input (such as commands) from a user and to provide output to the user. For example, the I/O components 116 may include a graphical user interface, keyboard, mouse, microphone and speakers, and so on.

The camera controller 110 may be configured to control the image sensor and optical element during modes. The camera controller 110 also may be configured to process frames captured by the image sensor 103. The camera controller 110 include an image signal processor 112, which may be one or more image signal processors to process captured image frames or video provided by the image sensor 103. In some implementations, the camera controller 110 (such as the image signal processor 112) also may control switching the device 100 between modes. In some aspects, the image signal processor 112 may execute instructions from a memory (such as instructions 108 from the memory 106 or instructions stored in a separate memory coupled to the image signal processor 112). In some other aspects, the image signal processor 112 may include specific hardware to perform one or more operations described in the present disclosure. The image signal processor 112 alternatively or additionally may include a combination of specific hardware and the ability to execute software instructions.

A device (such as the device 100) may include an image sensor that is shared by two or more optical paths. In this manner, the device may capture images or video using one image sensor similar to devices using multiple image sensors. For example, one image sensor may be used to capture images from different perspectives associated with multiple lenses on a single side of a device.

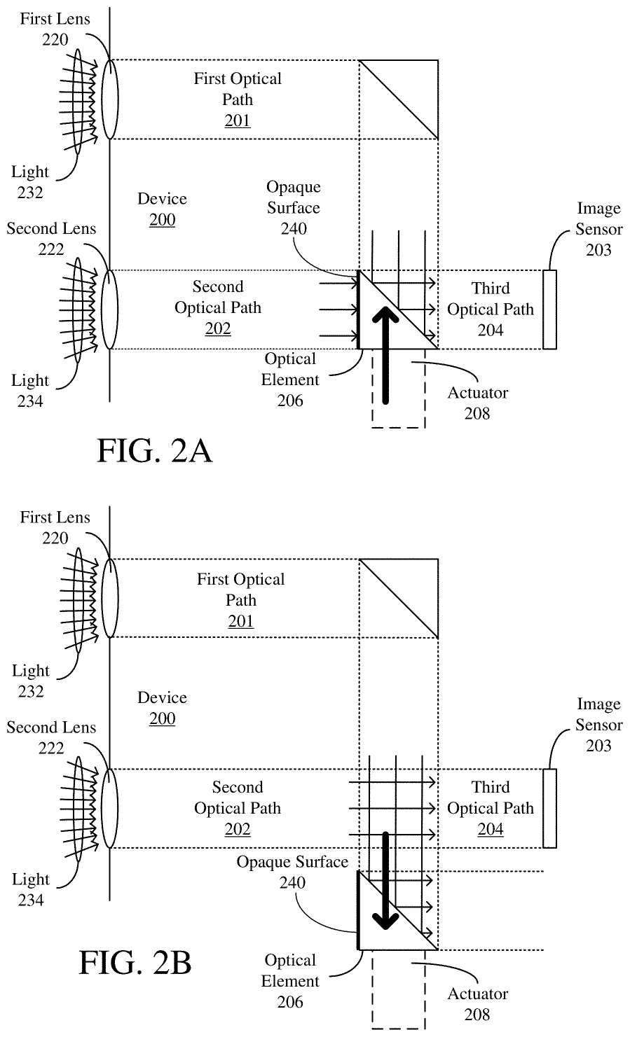

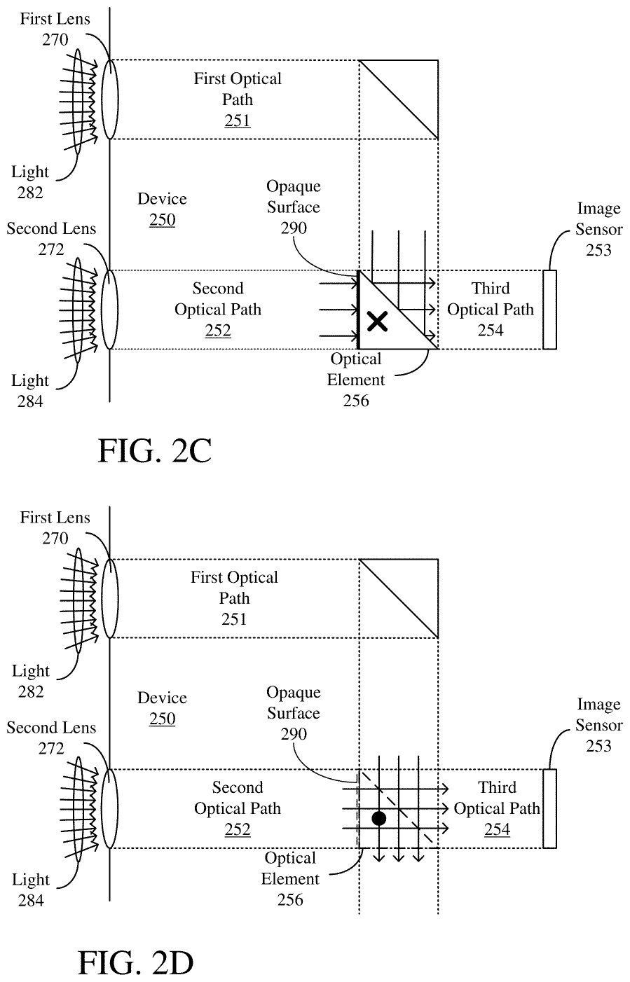

FIG. 2A is a depiction of a device 200 in a first mode configured to direct light 232 from a first optical path 201 to an image sensor 203. The device 200 may be an example implementation of the device 100 in FIG. 1. The first lens 220 and the second lens 222 may be positioned on the same side of the device 200, and the light 232 (received at the first lens 220) and the light 234 (received at the second lens 222) may be from the same side of the device 200. For example, the lenses 220 and 222 may be positioned on a rear side of a device (such as on the opposite side as a display on a smartphone) and configured to receive light at the rear side of the device, or the lenses 220 and 222 may be positioned on a front side of a device (such as on the same side as the display on the smartphone) and configured to receive light at the front side of the device.

In the first mode, the device 200 is configured to direct light from the first optical path 201 to the image sensor 203. In some implementations, an optical element 206 is positioned to couple the first optical path 201 and a third optical path 204 such that light 232 is received at the image sensor 203. The optical element 206 may include a reflective surface to reflect the light from the first optical path 201 to the third optical path 204. The optical element is illustrated as a triangle for illustrative purposes, and the optical element may be any suitable shape or component for directing light from the first optical path 201 to the third optical path 204. In some implementations, an actuator 208 may be coupled to the optical element 206, and the device 200 may control the actuator 208 to position the optical element 206. For example, the actuator 208 may laterally move the optical element 206 (as illustrated by the arrow) to position the optical element 206 to reflect light from the first optical path 201 to the third optical path 204 preceding the image sensor 203. In some implementations, lateral movement may refer to movement along a plane 90 degrees to a reference plane formed by the first optical path and the second optical path. The plane may be parallel to the lenses. For example, if the device 200 is a smartphone or tablet with its surface area primarily along a plane, lateral movement may refer to movement along the plane.

In some implementations, the device 200 prevents a second optical path 202 from being coupled to the third optical path 204 during the first mode. In this manner, the light 234 received at the second lens 222 and travelling along the second optical path 202 is prevented from being received at the third optical path 204 during the first mode. For example, the optical element 206 may include an opaque surface 240 to block the light 234 from being received at the third optical path 204.

In some implementations, the actuator 208 may include a spring load system or other mechanical module for moving the optical element 206. The actuator 208 may be electrically controlled (such as an electric motor), magnetically or electromagnetically controlled, or mechanically controlled (such as a physical switch or slider). The actuator 208 may be any suitable configuration and operation of the actuator 208 may be any suitable manner, and the disclosure is not limited to a specific example.

FIG. 2B is a depiction of the device 200 in a second mode configured to direct light 234 from a second optical path 202 to the image sensor 203. In the second mode, the device 200 is configured to couple the second optical path 202 to the third optical path 204 in order to direct light from the second optical path 202 to the image sensor 203. In some implementations, an optical element 206 is positioned such that the opaque surface 240 does not block light along the second optical path 202 (and thus the light travels to the third optical path 204). In this manner, the second optical path 202 may be coupled to the third optical path 204. For example, the optical element 206 is moved by the actuator 208 (as illustrated by the arrow) so that the opaque surface 240 is out of the second optical path 202, and the light from the second optical path 202 may be received at the third optical path 204 coupled to the second optical path 202 in the second mode.

When the device 200 is in the second mode, the light from the first optical path 201 is not directed by the optical element 206 to the third optical path 204. For example, the optical element 206 may be moved between a first position for a first mode and a second position for a second mode. When the optical element 206 is in a second position, the light from the first optical path 201 may be directed (such as reflected) to somewhere other than the third optical path 204. While the optical element 206 is described as being used for preventing light travelling along the first optical path 201 or the second optical path 202 from being received at the third optical path, any other suitable means may be used for preventing light along one optical path from being received at the third optical path 204. For example, one or more shutters or other optical deflection objects may be used to prevent light from reaching the image sensor 203.

FIGS. 2A and 2B illustrate the optical element 206 moving along an axis laterally within the device 200. For example, if the first lens 220 and the second lens 222 are oriented vertically (for example, when a smartphone is in a portrait orientation), the optical element 206 is illustrated as moving vertically. In some other implementations, the optical element 206 may be configured to move horizontally or in another suitable direction for the device 200 to switch between a first mode and a second mode.

FIG. 2C is a depiction of a device 250 in a first mode configured to direct light 282 from a first optical path 251 to an image sensor 253. In the first mode, the device 250 is configured to direct light from the first optical path 251 to the image sensor 253. The configuration of the device 250 in the first mode may be similar to the configuration of the device 200 in the first mode (FIG. 2A). The optical element 256 is positioned to couple the first optical path 251 and a third optical path 254 such that light 282 is received at the image sensor 253. The optical element 256 may include a reflective surface to reflect the light from the first optical path 251 to the third optical path 254. In some implementations, the device 250 may control an actuator to position the optical element 256. For example, the actuator may move the optical element 256 laterally (as illustrated by the x and 90 degrees to the movement of the optical element 206 in FIGS. 2A and 2B) to position the optical element 256 to reflect light from the first optical path 251 to the third optical path 254 preceding the image sensor 253. Similar to FIG. 2A, the device 250 may prevent a second optical path 252 from being coupled to the third optical path 254 during the first mode. In this manner, the light 284 received at the second lens 272 and travelling along the second optical path 252 is prevented from being received at the third optical path 254 during the first mode. For example, the optical element 256 may include an opaque surface 290 to block the light 284 from being received at the third optical path 254.

FIG. 2D is a depiction of the device 250 in a second mode configured to direct light 284 from a second optical path 252 to the image sensor 253. In the second mode, the device 250 is configured to couple the second optical path 252 to the third optical path 254 in order to direct light from the second optical path 252 to the image sensor 253. In some implementations, an optical element 256 is positioned such that the opaque surface 290 does not block light along the second optical path 252 (and thus the light travels to the third optical path 204). As illustrated by the dot, the optical element 256 may be moved horizontally (or in another suitable direction) to couple the second optical path 252 to the third optical path 254. For example, the optical element 256 is moved so that the opaque surface 290 is out of the second optical path 252, and the light from the second optical path 252 may be received at the third optical path 254 coupled to the second optical path 252 in the second mode.

When the device 250 is in the second mode, the light from the first optical path 251 is not directed by the optical element 256 to the third optical path 254. For example, the optical element 256 may be moved between a first position for a first mode and a second position for a second mode. When the optical element 256 is in a second position, the optical element is not in the first optical path 201. For example, the optical element 256 may be to either the proximal side or the distal side (from the illustrated perspective) of the first optical path. In this manner, light from the first optical path 201 is not directed (such as reflected) to the third optical path 204. The following examples show the optical element as being moved in a similar direction as in FIGS. 2A and 2B to illustrate concepts of the disclosure. However, the optical element may be moved in any suitable manner and direction (such as illustrated in FIGS. 2C and 2D or in another suitable direction), and the disclosure is not limited to a specific direction of movement of an optical element.

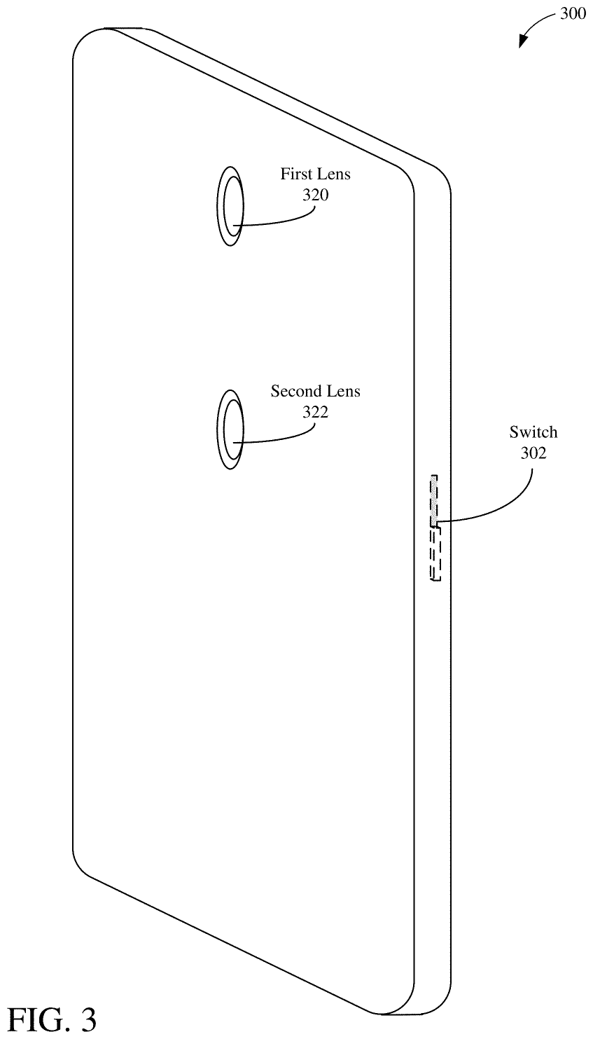

FIG. 3 is a depiction of an example device 300 including a first lens 320 and a second lens 322 on a rear of the device 300. The device 300 may be an example implementation of the device 200 in FIGS. 2A and 2B or the device 250 in FIGS. 2C and 2D. As illustrated, the device 300 may be a smartphone or tablet. The first lens 320 may be configured to receive light for a first mode of the device 300, and the second lens 322 may be configured to receive light for a second mode of the device 300.

In some implementations, the first lens 320 and the second lens 322 may be configured to provide different perspectives for an image sensor. For example, the lenses 320 and 322 may be toed-in or toed-out from each other. In some other implementations, the lenses 320 and 322 provide different fields of view. For example, the first lens 320 may be configured to provide a wide view (such as based on a curvature of the lens, the lens including a mask, and so on), and the second lens 322 may be configured to provide a telephoto view. In this manner, the device 300 may switch between capturing wide view images in a first mode and capturing telephoto view images in a second mode. In some implementations, the device 300 may switch between the first mode and the second mode through use of a switch 302. The switch 302 may be a slider or other manual component to be operated by a user, and may cause an optical element to be moved using mechanical or electrical means.

The device 300 may use additional or alternative means of switching between the first mode and the second mode. In some implementations, a display of the device 300 may display a button or other element that, when touched, causes the device 300 to switch between modes. For example, the device 300 may execute a camera application for capturing images or video. In executing the camera application, the device 300 may display a graphical user interface (GUI) for the camera application, and the GUI may include a button or other interactive element for the user to determine when the device 300 is to switch between modes. In some other implementations, the device 300 may include a microphone configured to receive a voice command for switching between modes. For example, the device 300 may use a microphone to listen for a wake word and a subsequent command following the wake word (such as “switch camera lens modes” and so on). In some other implementations, the device 300 includes a button or other physical means for a user to instruct the device 300 to switch modes.

In some further implementations, the device 300 may automatically control switching between the first mode and the second mode without requiring a user input. For example, the device 300 may automatically determine when to switch modes based on tracking an object, based on moving objects in a region of interest (ROI) in the scene, based on whether a zoom is to be performed, based on whether a depth disparity function is to be performed (such as a bokeh effect), and so on. For example, the first lens 320 may be a telephoto lens, and the second lens 322 may be a wider angle lens associated with a lower zoom factor than the first lens 320. If the device 300 is to generate an image of an object with a bokeh effect, the device may capture an image in the first mode (using the telephoto lens), automatically switch between the first mode and the second mode, and capture an image in the second mode (using the wider angle lens). The device 300 may then compare the images to determine differences in depth and thus identify a boundary of the object. In this manner, the background of the object is identified and blurred to generate the bokeh effect.

In another example, the device 300 may be configured to track an object in the field of view (FOV) of the first lens 320 or the second lens 322. The FOV of the second lens 322 may be greater than the FOV of the first lens 320. In some implementations, the device 300 switches between the modes to ensure that the object stays within the FOV of the active lens. For example, the device 300 may begin capturing images of the object in a first mode. The device 300 may also determine whether the object is to leave the FOV of the first lens 320 (such as by estimating a future position of the object). If the device 300 determines that object is to leave the FOV of the first lens 320, the device 300 may automatically switch to the second mode to use the second lens 322 associated with the larger FOV.

In a further example, the device 300 may be configured to switch modes based on a depth of an object in a FOV of the lenses 320 and 322. For example, the device 300 may determine a depth of an object in an ROI (such as via a depth sensor, contrast detection, phase detection, and so on). The device 300 may then use the first mode (associated with a higher optical zoom than the second mode) for image capture of the object if the depth is greater than a threshold depth. The device 300 may also switch between modes based on the object's depth crossing the threshold depth. While some example implementations of configuring the device 300 to switch between modes are provided, the device 300 may use any suitable means for switching between modes.

In some implementations, the first lens 320 and the second lens 322 may be associated with different zoom factors. For example, the curvatures of the first lens 320 and the second lens 322 may differ such that the first mode is associated with a first optical zoom and the second mode is associated with no optical zoom or an optical zoom less than the first optical zoom. While FIGS. 2A, 2B, 2C, 2D, and 3 illustrate the lenses being positioned on a same side of the device, the lenses may be positioned on different sides of the device for some other implementations.

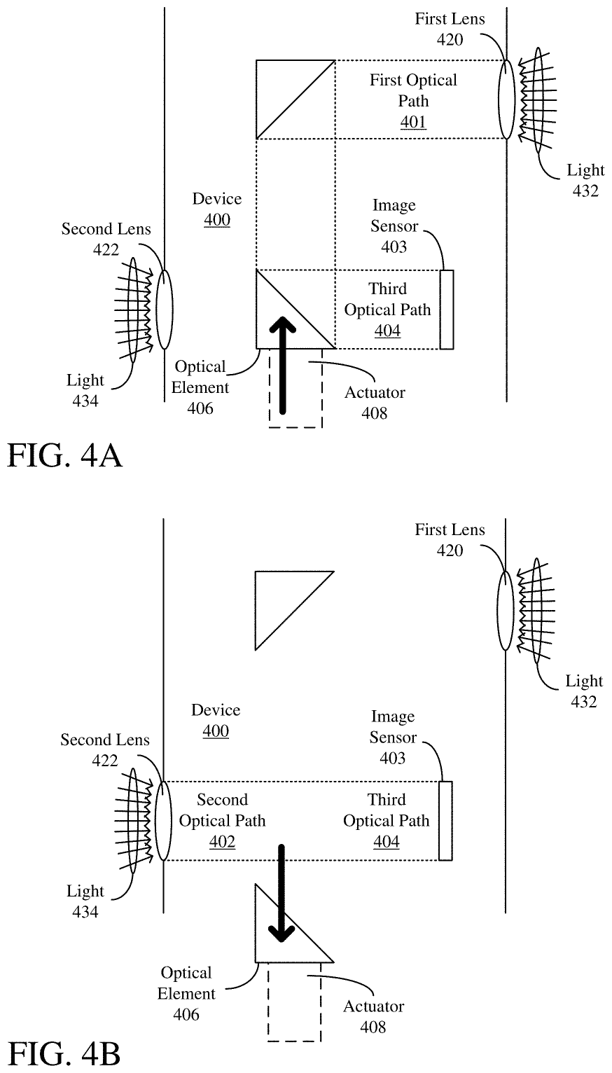

FIG. 4A is a depiction of a device 400 in a first mode configured to direct light 432 from a first optical path 401 to an image sensor 403. The device 400 may be an example implementation of the device 100 in FIG. 1. The first lens 420 may be positioned on a first side of the device to receive light 432, and the second lens 422 may be positioned on a second side of the device to receive light 434. For example, the first lens 420 may be on a front side of a device (such as a front side of a smartphone with a display), and the second lens 422 may be on a rear side of the device (such as a rear side of the smartphone opposite the display). While FIGS. 4A and 4B illustrate the lenses 420 and 422 on opposite sides of a device 400, the lenses 420 and 422 may be on any side of the device 400 (such as a top and rear of the device, a front and top of the device, a top and bottom of the device, and so on).

In a first mode, the device 400 is configured to direct light 432 from a first optical path 401 to the image sensor 403. In some implementations, an optical element 406 is positioned such that the first optical path 401 is coupled to the third optical path 404. For example, the optical element 406 is moved by an actuator 408 (as illustrated by the arrow) to position the optical element to reflect light from the first optical path 401 to the third optical path 404.

FIG. 4B is a depiction of the device 400 in a second mode configured to direct light 434 from a second optical path 402 to an image sensor 403. In a second mode, the device 400 is configured to direct light 434 from a first optical path 402 to the image sensor 403. In some implementations, the optical element 406 is positioned out of the second optical path 402 (as illustrated by the arrow) such that the second optical path 402 is coupled to the third optical path 404. In this manner, the optical element 406 may be moved between a first position for a first mode and a second position for a second mode. For example, the first mode may be associated with a selfie mode to capture front facing images of the user, and the second mode may be associated with an image capture mode to capture rear facing images of the device 400.

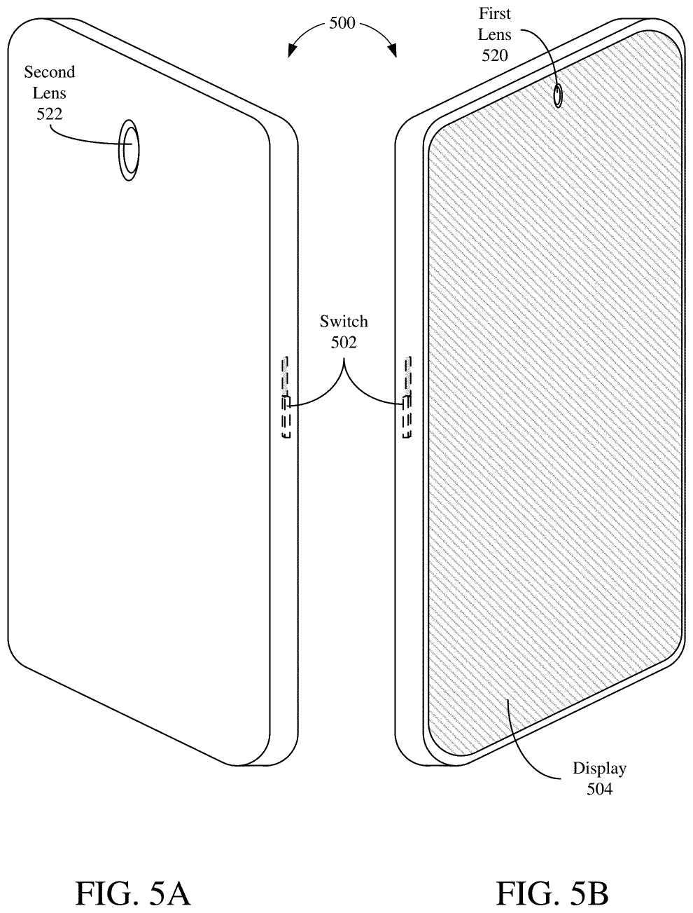

FIG. 5A is a depiction of an example device 500 including a second lens 522 on a rear of the device 500. The device 500 may be an example implementation of the device 400 in FIGS. 4A and 4B. As illustrated, the device 500 may be a smartphone or tablet. FIG. 5B is a depiction of the example device 500 including a first lens 520 on the front of the device. The first lens 520 may be configured to receive light for a first mode of the device 500, and the second lens 522 may be configured to receive light for a second mode of the device 500. The first lens 520 may be positioned on the front side of the device 500 with the display 504. Space separate from the display 504 on the front side of the device 500 may be made for the first lens 520 via, for example, a punch hole in the display 504 (as illustrated), a notch in the display 504, or a bezel of the device 500 outside of the display.

In some implementations, switching between the first mode and the second mode may be controlled by a switch 502 operated by a user. The switch 502 may be a slider or other manual component to be operated by a user, and may cause an optical element to be moved using mechanical or electrical means. In some other implementations, a device 500 may control switching between the first mode and the second mode by any other suitable means (such as described above with reference to FIG. 3).

FIGS. 2A-5B illustrate a position of the first lens and a position of the second lens being fixed with reference to each other. In some other implementations, a position of a first lens may move with reference to a position of the second lens. In some implementations, a first lens may be positioned outside of a display during a first mode of a device, and the first lens may be hidden behind the display during a second mode of the device. For example, when a smartphone is in a selfie mode, the smartphone may move a first lens from behind the display to outside of the display for capturing selfie images. When the smartphone is not in a selfie mode (such as when capturing an image using a second lens or not performing image capture), the first lens may be moved behind the display of the device. In this manner, the display may not include a punch hole or notch and the device may have small borders outside of the display while still including a front facing lens for image capture.

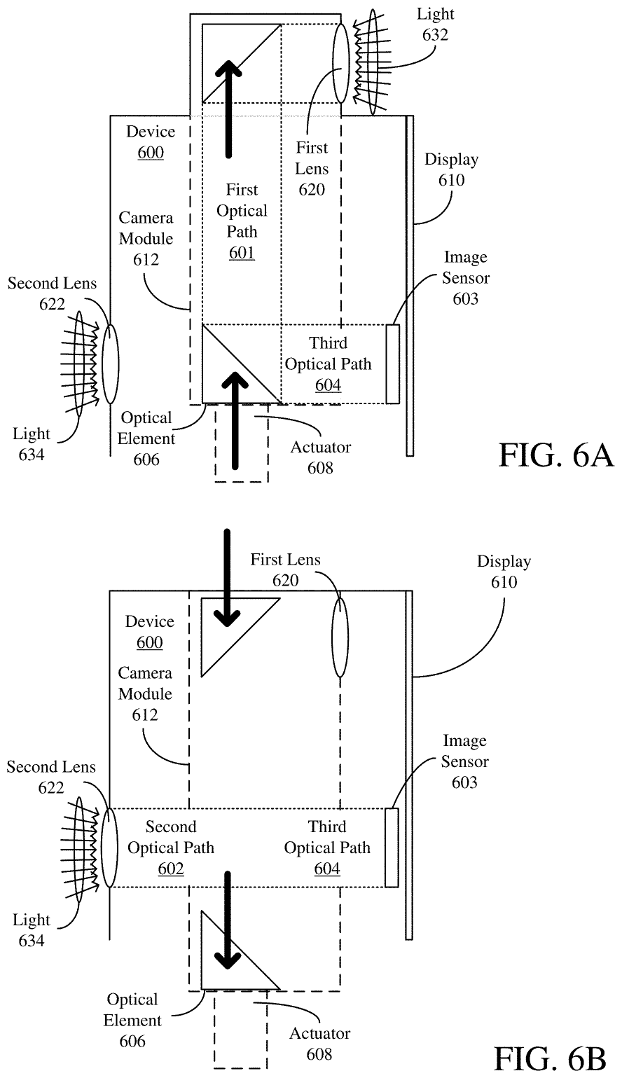

FIG. 6A is a depiction of an example device 600 in a first mode exposing a first lens 620 for directing light 632 to a first optical path 601, which is directed to the image sensor 603. As illustrated, the lens 620 may be positioned outside of the display 610 of the device 600 for a first mode (such as a selfie mode). In some implementations, the lens 620 may be included in a camera module 612 that moves between a first position (as illustrated) for a first mode of the device 600 and a second position (as illustrated in FIG. 6B) for a second mode of the device 600. In the first mode, the camera module 612 may be moved (as illustrated by the arrows) by actuator 608 to the first position, and the first lens 620 is outside of the display 610 to receive light 632. The camera module 612 also may include an optical element 606 to direct light from the first optical path 601 to the image sensor 603 when the device 600 is in the first mode. For example, the optical element 606 may be moved to a first position to reflect light from the first optical path 601 to a third optical path 604 preceding the image sensor 603. In some implementations, light 634 received at the second lens 622 is prevented from being received at the third optical path when the device 600 is in the first mode.

FIG. 6B is a depiction of the example device 600 in a second mode hiding the first lens 620 and configured to direct light from a second optical path 602 to the image sensor 603. In the second mode, the camera module may be positioned to hide the first lens 620 behind the display 610 and move the optical element 606 out of the second optical path 602. In this manner, the light 634 directed by the second lens 622 to the second optical path 602 may be received at the third optical path 604 and the image sensor 603.

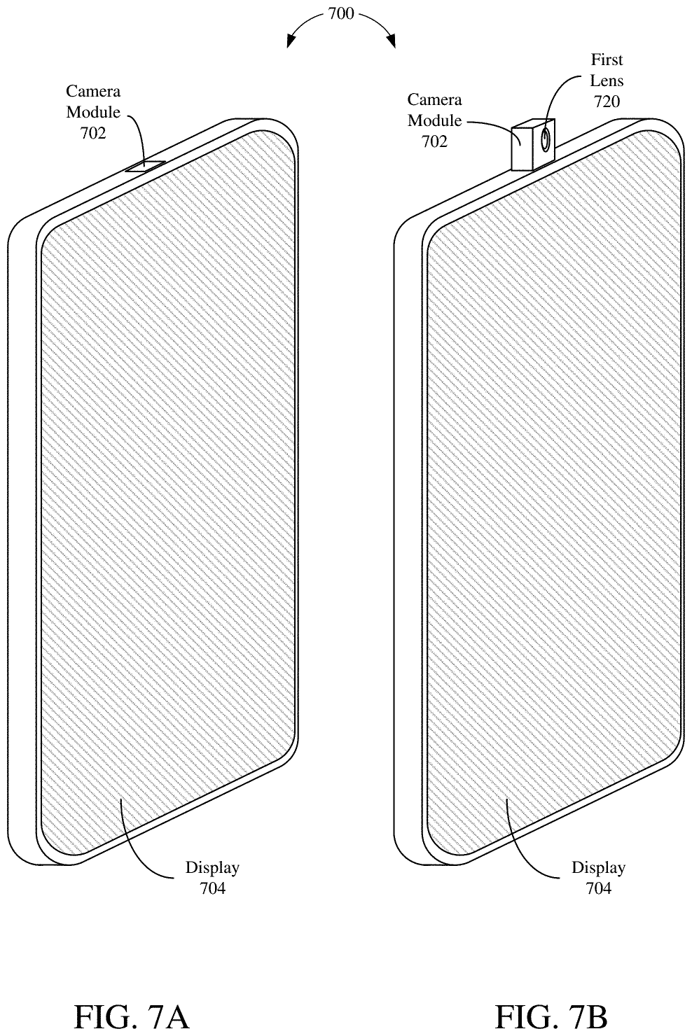

FIG. 7A is a depiction of an example device 700 with a first lens hidden by a camera module 702 behind a display 704. FIG. 7B is a depiction of the device 700 with the first lens 720 positioned by the camera module 702 outside of the display 704. The device 700 may be an example implementation of the device 600 in FIGS. 6A and 6B. As shown, the display 704 may include more space of the front of the device 700 than if the lens 720 is fixed on the front of the device 700 (such as not including a punch hole or notch).

As noted above, a first mode may be associated with a first optical zoom (such as an optical zoom greater than zero), and a second mode may be associated with a second optical zoom (such as an optical zoom less than the optical zoom associated with the first optical path). If the device is a smartphone, the depth of a smartphone may limit the number of lenses that may be arranged in an optical path. For example, referring back to FIG. 2B, the distance between the second lens 222 and the image sensor 203 for a smartphone may limit the ability to place one or more lenses (adjusting the optical zoom) between the second lens 222 and the image sensor 203. However, the first optical path 201 may include a portion parallel to the length of the smartphone, which may allow one or more lenses (adjusting the optical zoom) to be between the first lens 220 and the image sensor 203. Additionally, some devices may include one or more shutters to prevent light from being directed by a lens to its associated optical path.

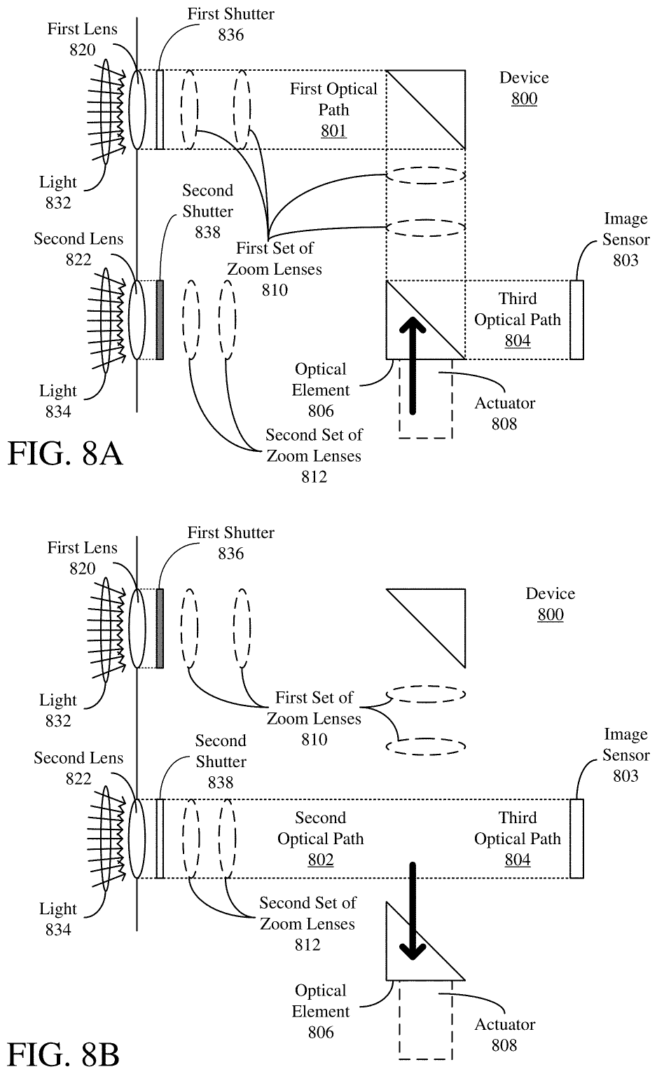

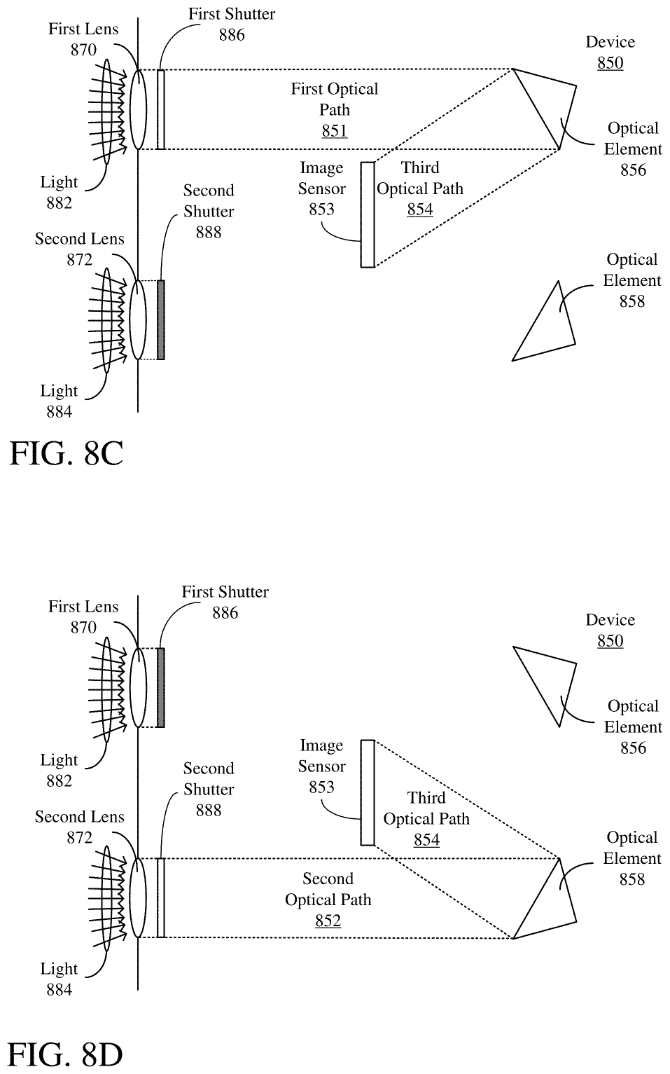

FIG. 8A is a depiction of a device 800 in a first mode configured to direct light 832 from a first optical path 801 to an image sensor 803. The device 800 may be an implementation of the device 200 (FIGS. 2A and 2B) or the device 100 (FIG. 1). The device 800 may include a first set of zoom lenses 810 in the first optical path 801. The first set of zoom lenses 810 may be one or more optical lenses configured to adjust an optical zoom of image capture for the device 800 in a first mode. Similar to FIG. 2A, the optical element 806 may be in a first position to direct light from the first optical path 801 to the third optical path 804 and the image sensor 803. The optical element 806 may be moved between positions by an actuator 808.

While the first set of zoom lenses is illustrated as including lenses in a lateral portion and a vertical portion of the first optical path 801, the optical zoom lenses may exist in the vertical portion of the first optical path 801, the horizontal portion of the first optical path 801, or both portions of the first optical path 801. In some implementations, the second lens 822 (that receives light 834) may be associated with a second set of zoom lenses 812 to adjust an optical zoom of image capture for the device 800 in a second mode. In some other implementations, the device 800 may not include a second set of zoom lenses 812.

In some implementations, the device 800 may be configured to use shutters to prevent light 832 or light 834 from reaching an image sensor. For example, when the device 800 is in a first mode, the device 800 may close a second shutter 838 to prevent light 834 from entering further into the device 800. In some other implementations, the light 834 may be prevented from reaching the image sensor 803 by other means during the first mode. For example, the optical element 806 may be configured to block light 834 from reaching the third optical path 804 and the image sensor 803 (such as illustrated in FIGS. 2A-2D). Other suitable means for preventing light from reaching the image sensor 803 may be used, and the disclosure is not limited to shutters or the optical element preventing light from reaching the image sensor 803. In some implementations of using shutters, the device 800 may open a first shutter 836 in the first optical path 801 during the first mode. In this manner, light 820 is allowed to reach the first optical path 801 and travel to the third optical path 804.

FIG. 8B is a depiction of a device 800 in a second mode configured to direct light 834 from a second optical path 802 to an image sensor 803 (such as via a third optical path 804). Similar to FIG. 2B, the optical element 806 may be in a second position to allow the device 800 to direct light 834 from the second optical path 802 to the third optical path 804 and the image sensor 803. The device 800 may include a number of zoom lenses (greater than or equal to zero) in the second optical path 802, which may be referred to as a second set of zoom lenses 812. While the device 800 is illustrated as including the second set of zoom lenses 812 along the second optical path 802, the device 800 may not include the second set of zoom lenses 812 (and the device 800 not be associated with an optical zoom for image capture during the second mode). In some implementations, the device 800 may be configured to open a second shutter 838 and close a first shutter 836 when the device 800 is in the second mode. In this manner, light 832 may be prevented from entering further into the device 800. In some other implementations, the light 832 may be prevented from reaching the image sensor 803 by other means during the first mode. For example, the device 800 may not include a first shutter 836, as the optical element 806 is positioned during a second mode to not direct light from the first optical path 801 to the image sensor 803.

In this manner, each optical path 801 and 802 may be associated with a different optical zoom. While FIGS. 8A and 8B illustrate the lenses 820 and 822 located on a same side of the device 800 (such as illustrated in FIGS. 2A and 2B), aspects of FIGS. 8A and 8B may be implemented in a device with different lens positions (such as in FIGS. 4A and 4B, in FIGS. 6A and 6B, or devices with other positions of the lenses not illustrated).

In some implementations, shutters can be used without a moveable optical element. For example, whether light from a first optical path reaches a third optical path via a fixed optical element may be based on whether the shutter for the first optical path is open. FIGS. 8C and 8D illustrate an example implementation of a device with one or more fixed optical elements and shutters for directing light from a first or second optical path to a third optical path.

FIG. 8C is a depiction of a device 850 in a first mode configured to direct light 882 from a first optical path 851 to an image sensor 853. The device 850 may be an implementation of the device 100 (FIG. 1). The device 850 includes a first lens 870 to direct light 882 from outside the device toward the first shutter 886. The device 850 also includes an optical element 856 to direct light from the first optical path 851 to the third optical path 854, which is received by the image sensor 853. When the device 850 is in a first mode, the first shutter 886 is open to direct light from the first lens 870 to the first optical path 851. The device 850 also includes a second lens 872 to direct light 884 from outside the device 850 toward the second shutter 888. When the device 850 is in the first mode, the second shutter 888 is closed, preventing light 884 from passing through the second shutter 888 and reaching the image sensor 853 via the optical element 858.

FIG. 8D is a depiction of the device 850 in a second mode configured to direct light 884 from a second optical path 852 to the image sensor 853. When the device 850 is in a second mode, the second shutter 888 is open to direct light from the second lens 870 to the second optical path 852. The device 850 also includes a second lens 872 to direct light 884 from outside the device 850 toward the second shutter 888. When the device 850 is in the second mode, the first shutter 886 is closed, preventing light 882 from passing through the first shutter 886 and reaching the image sensor 853 via the optical element 856.

While not shown, the device 850 may include one or more sets of zoom lenses, such as illustrated in FIGS. 8A and 8B. Additionally, while FIGS. 8C and 8D illustrate multiple optical elements 856 and 858, a single optical element may be used to direct light from the first optical path 851 or the second optical path 852 toward the image sensor 853. For example, the optical element may be a prism configured to receive light from different directions and direct the received light to the same optical path for the image sensor 853. While the device 850 is illustrated as including the first lens 870 and the second lens 872 on a same side of the device 850, the lenses may be configured on any suitable side or in any suitable manner (such as described above).

As illustrated in FIGS. 8C and 8D, the third optical path 854 may not be perpendicular to the image sensor 853 if stationary. In some implementations, the image sensor 853 rotates or otherwise moves to prevent perspective distortion. For example, the image sensor 853 may rotate to a first position perpendicular to the third optical path 854 in the first mode (FIG. 8A), and the image sensor 853 may rotate to a second position perpendicular to the third optical path 854 in the second mode (FIG. 8B). In some other implementations, the device 850 processes images post-capture from the image sensor 853 to remove or reduce the perspective distortion.

FIGS. 2A-8B illustrate moving an optical element to allow light from a second optical path to reach a third optical path and the image sensor. For example, the optical element may be laterally moved out of the second optical path during a second mode. In some other implementations, the optical element may be configured to actively direct light from a second optical path to the image sensor during a second mode.

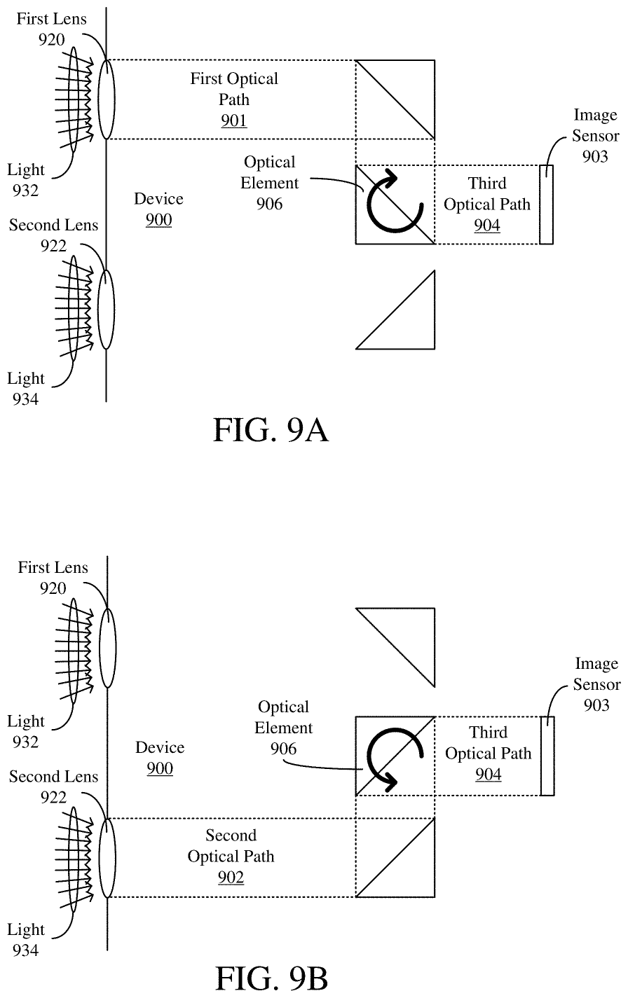

FIG. 9A is a depiction of a device 900 in a first mode configured to direct light 932 from a first optical path 901 to an image sensor 903. The device 900 may be an example implementation of the device 100 in FIG. 1. During the first mode, the optical element 906 may be in a first position to direct light 932 from the first lens 920 and the first optical path 901 to the third optical path 904 and the image sensor 903. For example, the device 900 may rotate (as illustrated by the arrow) the optical element 906 to the first position. During the first mode, the device 900 prevents the light 934 from being received at the image sensor 903. For example, the device 900 may include a closed shutter during the first mode to prevent the light 934 from entering further into the device 900, the optical element 906 may be positioned to prevent light 934 from reaching the image sensor 903 (as illustrated), or other means may be used to prevent the light 934 from reaching the image sensor 903.

FIG. 9B is a depiction of the device 900 in a second mode configured to direct light 934 from a second optical path 902 to an image sensor 903. During the second mode, the optical element 906 may be in a second position to direct light 934 from the second lens 922 and the second optical path 902 to the third optical path 904 and the image sensor 903. For example, the device 900 may rotate (as illustrated by the arrow) the optical element 906 to the second position. During the second mode, the device 900 prevents the light 932 from being received at the image sensor 903. For example, the device 900 may include a closed shutter during the second mode to prevent the light 932 from entering further into the device 900, the optical element 906 may be positioned to prevent light 932 from reaching the image sensor 903 (as illustrated), or other means may be used to prevent the light 932 from reaching the image sensor 903. While not illustrated, the device 900 may include one or more sets of optical zoom lenses or other aspects as disclosed above for different implementations of a device.

An optical element is illustrated as being laterally moved or rotationally moved. However, the optical element may be adjusted in any suitable means to allow the device to direct light from a specific optical path to the image sensor. For example, the optical element may include one or more deformable mirrors based on micro-electric mechanical systems (MEMS), thermally deformable mirrors, electrically deformable mirrors, and so on.

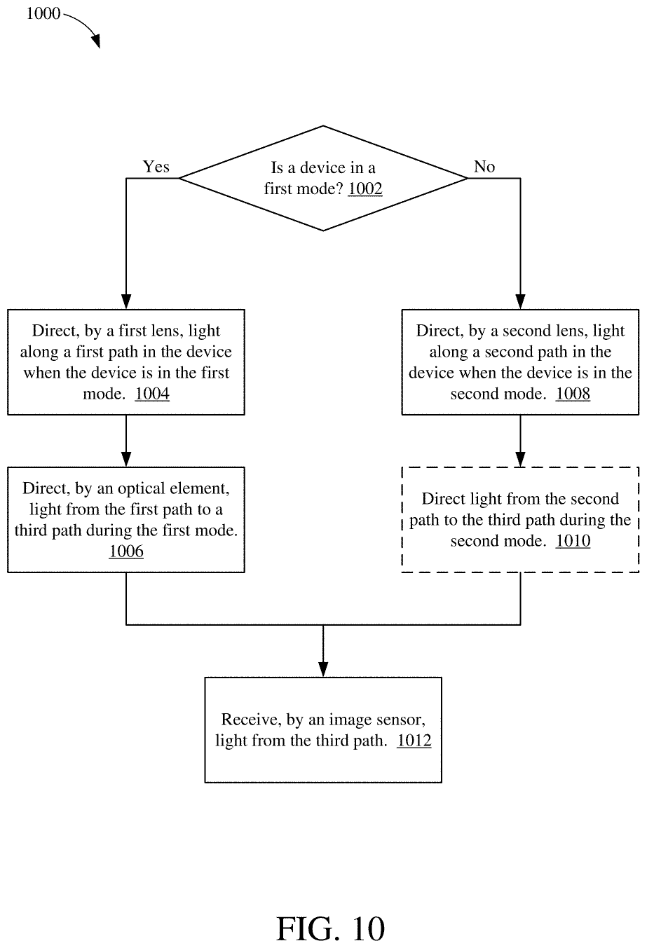

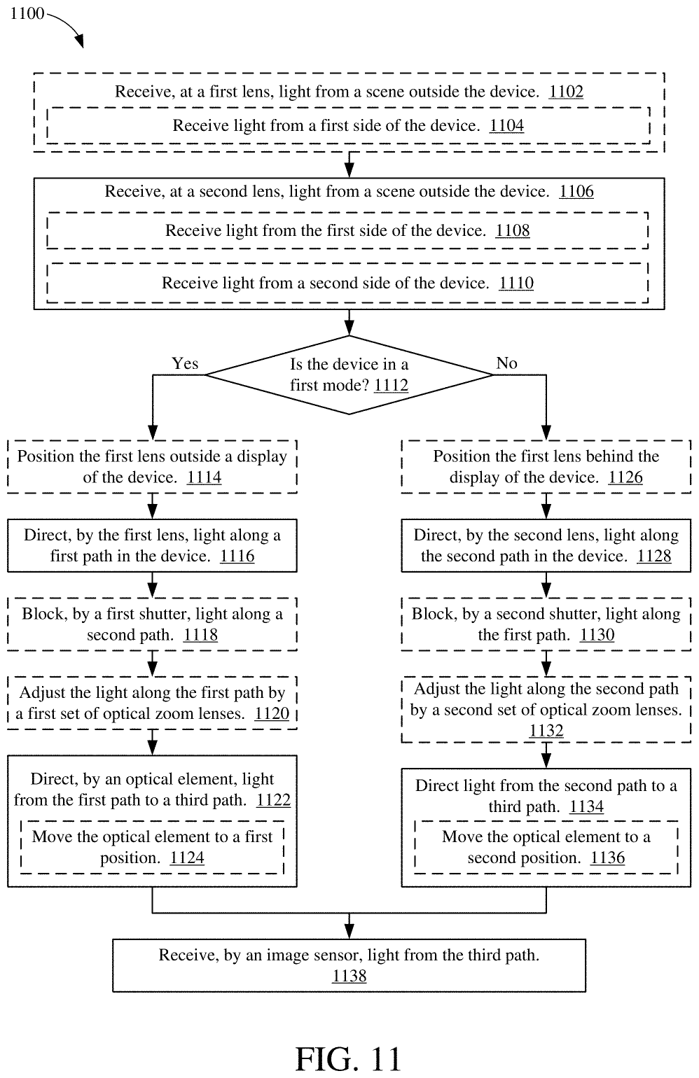

FIG. 10 is an illustrative flow chart depicting an example operation 1000 for sharing an image sensor between multiple optical paths. While example operation 1000 and example operation 1100 (FIG. 11) is described as being performed by device 100 in FIG. 1, operation 1000 or operation 1100 may be performed by any suitable device, including devices 200, 300, 400, 500, 600, 700, 800, or 900. Additionally, while two optical paths and associated lenses sharing an image sensor are described, any number of optical paths and associated lenses may share the image sensor. For example, three or more lenses may share one image sensor.

Referring to the example operation 1000, if the device 100 is in a first mode (1002), the device 100 may direct, by a first lens 120, light along a first path in the device 100 (1004). For example, the first lens 120 may direct incoming light to a first optical path 101. The device 100 may then direct, by an optical element, light from the first path to a third path (1006). For example, an optical element may be in a first position to direct light from a first optical path 101 to a third optical path preceding the image sensor 103. The image sensor 103 may then receive the light from the third path (1012). Referring back to decision block 1002, if the device 100 is not in a first mode, the device 100 may direct, by a second lens 122, light along a second path in the device 100 (1008). For example, the second lens 122 may direct incoming light to a second optical path 102. The device 100 may then direct light from the second path to the third path (1010). For example, an optical element may be moved into a second position to allow light from a second optical path 102 to be received at a third optical path preceding the image sensor 103. In some implementations, the optical element may actively direct light (such as reflect light) from the second optical path to the third optical path. The light from the third path may then be received by the image sensor 103 (1012).

As noted above, each optical path may be associated with a different optical zoom, a different perspective, or a different field of view. The device 100 may include one or more optical lenses, various orientations of the lenses 120 and 122, a camera module to move a first lens 120, or other components.

FIG. 11 is an illustrative flow chart depicting another example operation 1100 for sharing an image sensor (such as image sensor 103) between multiple optical paths (such as optical paths 101 and 102). The operation 1100 illustrates possible differences between the optical paths and of image capture during different modes. In some implementations, a first lens 120 may receive light from outside the device 100 (1102). For example, if the first lens 120 is fixed to a side of the device 100, the first lens 120 may be configured to receive light without reference to whether the device 100 is in a first mode or another mode (such as a second mode). For example, the first lens 120 may receive light incident to a first side (which may be referred to as from a first side) of the device 100 (1104). If the first lens is associated with a selfie mode, the first lens 120 may receive light from a front of the device 100. If the first lens 120 is located on a rear of the device 100, the first lens 120 may receive light from the rear of the device 100. In some other implementations, the first lens 120 may not be exposed outside of the device 100 other than during a first mode. For example, the first lens 120 may be positioned behind a display when the device is in a second mode (using the second lens 122). In this manner, the first lens 120 may not always be configured to receive light from a scene outside the device.

At 1106, the second lens 122 may receive light from a scene outside the device 100. In some implementations, the second lens 122 may receive light from the first side of the device (1108), similar to the first lens 120. For example, the first lens 120 and the second lens 122 may be located on a same side of the device 100. In some other implementations, the second lens 122 may receive light from the second side of the device (1110). For example, the first lens 120 may be located on a front of the device 100, and the second lens 122 may be located on a rear of the device 100.

At 1112, if the device 100 is in a first mode, the first lens 120 may be positioned outside of a display (1114). For example, if the first lens 120 is moved based on a mode of the device 100 (such as behind a display during a second mode), the device 100 may position the first lens 120 from behind the display. Otherwise, the first lens 120 may be fixed to a first side of the device or otherwise not be positioned behind a display. At 1116, the first lens 120 may direct light received from outside the device along a first optical path 101.

In some implementations, a first shutter along the second optical path 102 may be closed to block light along the second optical path 102 (1118). In some other implementations, light from the second lens 122 may not be prevented from travelling along the second optical path 102. Referring back to the first optical path 101, the light along the first optical path 101 may be adjusted by a first set of optical zoom lenses in some implementations (1120). At 1122, the light also may be directed by an optical element from the first optical path 101 to a third optical path preceding the image sensor 103. In some implementations, the device 100 may move the optical element to a first position when the device 100 is in the first mode (1124). The image sensor 103 may then receive the light from the third optical path (1138).

Referring back to decision block 1112, if the device 100 is not in the first mode (such as the device being in a second mode), the device 100 may position the first lens 120 behind a display in some implementations (1126). In some other implementations, the first lens 120 may not be hidden behind a display. For example, the first lens 120 may be located on a rear of the device 100, in a notch of the display, in a punch hole of the display, in a border of the device 100 outside the display, and so on.

At 1128, the second lens 122 may direct light received from outside the device 100 along the second optical path 102. In some implementations, a second shutter along the first optical path 101 may be closed to block light along the first optical path 101 (1130). In some other implementations, light may not be received at the first lens 120 if the first lens 120 is behind a display. In some other implementations, light may not be prevented from travelling along the first optical path 101.

Referring back to the second optical path 102, the light along the second optical path 102 may be adjusted by a second set of optical zoom lenses in some implementations (1132). In some other implementations, only the first optical path 101 may include a set of zoom lenses, and the light along the second optical path 102 may not be adjusted by a set of zoom lenses. At 1134, the light along the second optical path 102 may be directed to the third optical path preceding the image sensor 103. In some implementations, the device 100 may move the optical element to a second position when the device 100 is in the second mode (1136). For example, the optical element may be moved out of the second optical path 102 to allow light from the second optical path 102 to reach the third optical path. In another example, the optical element may be moved (such as rotated) to a second position to reflect light from the second optical path 102 to the third optical path. The image sensor 103 may then receive the light from the third optical path (1138). In this manner, the image sensor 103 may capture images based on light from the first lens 120 or the second lens 122.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 306 in the example device 300 of FIG. 3) comprising instructions 308 that, when executed by the processor 304 (or the camera controller 310 or the image signal processor 312 or another suitable component), cause the device 300 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 304 or the image signal processor 312 in the example device 300 of FIG. 3. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, a camera may not be from a multiple camera system when performing one or more operations described in the present disclosure. For example, a device may include a single camera, and the frame capture rate of the single camera may be adjusted in placing the camera into and out of a low power mode. Additionally, the functions, steps or actions of the method claims in accordance with aspects described herein need not be performed in any particular order unless expressly stated otherwise. For example, the steps of the described example operations, if performed by the device 300, the camera controller 310, the processor 304, the image signal processor 312, one or both of the cameras 301 and 302, or another suitable component, may be performed in any order and at any frequency. Furthermore, although elements may be described or claimed in the singular, the plural is contemplated unless limitation to the singular is explicitly stated. For example, synchronizing frame capture may be performed for more than two cameras with overlapping fields of capture. Accordingly, the disclosure is not limited to the illustrated examples and any means for performing the functionality described herein are included in aspects of the disclosure.

What is claimed is:

1. A device for digital imaging, comprising:
a first lens configured to direct light along a first path in the device;
a second lens configured to direct light along a second path in the device;
an image sensor configured to receive light from a third path in the device; and
an optical element configured to direct the light from the first path to the third path during a first mode, wherein:
the image sensor is configured to receive the light from the first path during the first mode; and
the image sensor is configured to receive the light from the second path during a second mode.

2. The device of claim 1, further comprising:
an actuator coupled to the optical element, the actuator configured to move the optical element to a first position for the first mode and to a second position for the second mode.

3. The device of claim 2, wherein the optical element is further configured to:
reflect the light directed along the first path to the third path when the optical element is in the first position; and
allow the light directed along the second path to pass through to the third path when the optical element is in the second position.

4. The device of claim 3, further comprising:
a first set of optical zoom lenses along the first path associated with a first optical zoom, wherein the light directed along the first path passes through the first set of optical zoom lenses during the first mode; and
a second set of optical zoom lenses along the second path associated with a second optical zoom, wherein the light directed along the second path passes through the second set of optical zoom lenses during the second mode.

5. The device of claim 4, wherein a position of the first lens is fixed with reference to a position the second lens.

6. The device of claim 5, further comprising a display, wherein the position of the first lens and the position of the second lens are on a first side of the device opposite a second side of the device including the display.

7. The device of claim 3, wherein:
the first lens is configured to receive light incident to a first side of the device, wherein the image sensor is configured to capture one or more images of a scene corresponding to the first side of the device during the first mode; and
the second lens is configured to receive light incident to a second side of the device, wherein the image sensor is configured to capture one or more images of the scene corresponding to the second side of the device during the second mode.

8. The device of claim 7, wherein the second lens is fixed with respect to the image sensor.

9. The device of claim 8, further comprising a display, wherein:
the first side of the device includes the display; and
the second side of the device is opposite the first side of the device.

10. The device of claim 9, wherein the actuator is further configured to:
position the first lens outside the display during the first mode; and
position the first lens behind the display during the second mode.

11. The device of claim 2, wherein:
the actuator is configured to rotate the optical element to the first position during the first mode and the second position during the second mode;
the optical element is configured to reflect the light from the first path to the third path when the optical element is in the first position; and
the optical element is configured to reflect the light from the second path to the third path when the optical element is in the second position.

12. The device of claim 1, further comprising:
a first shutter configured to block light along the first path during the second mode; and
a second shutter configured to block light along the second path during the first mode.

13. A method for digital imaging, comprising:
directing, by a first lens, light along a first path in a device when the device is in a first mode;
directing, by a second lens, light along a second path in the device when the device is in a second mode;
receiving, by an image sensor, light from a third path in the device; and
directing, by an optical element, light from the first path to the third path during the first mode, wherein:
the image sensor is configured to receive the light from the first path during the first mode; and
the image sensor is configured to receive the light from the second path during the second mode.

14. The method of claim 13, further comprising:
moving, by an actuator coupled to the optical element, the optical element to a first position for the first mode and to a second position for the second mode.

15. The method of claim 14, further comprising:
reflecting, by the optical element, the light directed along the first path to the third path when the optical element is in the first position; and
allowing the light directed along the second path to pass through to the third path when the optical element is in the second position.

16. The method of claim 15, further comprising:
adjusting, by a first set of optical zoom lenses, the light directed along the first path during the first mode, wherein:
the first set of optical zoom lenses is associated with a first optical zoom; and
the light directed along the first path passes through the first set of optical zoom lenses during the first mode; and
adjusting, by a second set of optical zoom lenses, the light directed along the second path during the second mode, wherein:
the second set of optical zoom lenses is associated with a second optical zoom; and
the light directed along the second path passes through the second set of optical zoom lenses during the second mode.

17. The method of claim 16, further comprising receiving, at the first lens and at the second lens, light from outside the device, wherein a position of the first lens is fixed with reference to a position of the second lens.

18. The method of claim 17, further comprising receiving, at the first lens and at the second lens, light incident to a first side of the device opposite a second side of the device including a display.

19. The method of claim 15, further comprising:
receiving, at the first lens, light incident to a first side of the device;
receiving, at the second lens, light incident to a second side of the device;
capturing, by the image sensor, one or more images of a scene corresponding to the first side of the device during the first mode; and
capturing, by the image sensor, one or more images of the scene corresponding to the second side of the device during the second mode.

20. The method of claim 19, further comprising:
positioning, by the actuator, the first lens outside a display on the first side of the device during the first mode; and
positioning, by the actuator, the first lens behind the display during the second mode.

21. The method of claim 14, wherein:
rotating, by the actuator, the optical element to the first position during the first mode;
rotating, by the actuator, the optical element to the second position during the second mode;
reflecting, by the optical element, the light from the first path to the third path when the optical element is in the first position; and
reflecting, by the optical element, the light from the second path to the third path when the optical element is in the second position.

22. The method of claim 13, further comprising:
blocking, by a first shutter, light along the first path during the second mode; and
blocking, by a second shutter, light along the second path during the first mode.

23. A non-transitory, computer readable medium storing instructions that, when executed by a processor of a device, cause the device to:
direct, by a first lens, light along a first path in the device when the device is in a first mode;
direct, by a second lens, light along a second path in the device when the device is in a second mode;
receive, by an image sensor, light from a third path in the device; and
direct, by an optical element, light from the first path to the third path during the first mode, wherein:
the image sensor is configured to receive the light from the first path during the first mode; and
the image sensor is configured to receive the light from the second path during the second mode.

24. The computer readable medium of claim 23, wherein execution of the instructions further causes the device to:
move, by an actuator coupled to the optical element, the optical element to a first position for the first mode and to a second position for the second mode.

25. The computer readable medium of claim 24, wherein execution of the instructions further causes the device to:
capture, by the image sensor, one or more images of a scene corresponding to light received at the first lens during the first mode; and
capture, by the image sensor, one or more images of the scene corresponding to light received at the second lens during the second mode, wherein a position of the second lens is fixed with reference to a position of the first lens.

26. The computer readable medium of claim 24, wherein execution of the instructions further causes the device to:
positioning, by the actuator, the first lens outside a display on a first side of the device in a first mode, wherein the first lens is configured to receive light incident to a first side of the device; and
positioning, by the actuator, the first lens behind the display during the second mode.

27. A device, comprising:
means for directing light along a first path in the device when the device is in a first mode;
means for directing light along a second path in the device when the device is in a second mode;
means for receiving at an image sensor light from a third path in the device; and
means for directing light from the first path to the third path during the first mode, wherein:
the image sensor is configured to receive the light from the first path during the first mode; and
the image sensor is configured to receive the light from the second path during the second mode.

28. The device of claim 27, further comprising:
means for moving the means for directing light to a first position for the first mode and to a second position for the second mode.

29. The device of claim 28, further comprising:
means for capturing one or more images of a scene corresponding to light received at a first lens and directed along the first path during the first mode; and
means for capturing one or more images of the scene corresponding to light received at a second lens and directed along the second path during the second mode, wherein the a position of the second lens is fixed with reference to a position of the first lens.

30. The device of claim 28, further comprising:
means for positioning a first lens outside a display on a first side of the device in a first mode, wherein the first lens is configured to receive light incident to a first side of the device that is directed along the first path during the first mode; and
means for positioning the first lens behind the display during the second mode.
